(19) United States
(12) Patent Application Publication
(10) Pub. No.: US 2009/0063224 A1
(43) Pub. Date: Mar. 5, 2009

(54) Integrated and platform independent approach to modeling of business rules using business and application domain ontologies

(76) Inventors: Ravi Prakash Gorthi, Bangalore (IN); Manohar Moorthy, Bangalore (IN)

Correspondence Address: NIXON PEABODY, LLP, 401 9TH STREET, NW, SUITE 900, WASHINGTON, DC, 20004-2128, US

(21) Appl. No.: 11/896,595

(22) Filed: Sep. 4, 2007

(51) Int. Cl. G06Q 10/00; G06N 5/02

(52) U.S. Cl. 705/7; 706/47

(57) ABSTRACT

A method, system, and computer program product for integrated and platform independent modeling of business rules, including ***.

### BACKGROUND OF THE INVENTION

1. Field of the Invention

The present invention generally relates to the field of business rules modeling, and more particularly to a system and method for integrated and platform independent modeling of business rules using business and application domain ontologies.

2. Discussion of the Background

Business rules are used by almost all the business enterprises to serve one or more purposes, such as consistency and clarity in business procedures, operations, decision making, etc. Information Technology (IT) systems, which are used to facilitate the automation of business operations, need to define code to apply appropriate business rules. Traditionally, IT systems have been hard-coding such business rules into the business procedural logic, as shown in FIG. 1. However, a major problem with this approach is that business rules change frequently (e.g., weekly, monthly, etc.). For example, enterprises may change rules associated with business operations, products, and services periodically, because of changes in government regulations or in response to market dynamics. When such changes occur, the IT system code needs to be changed and regression testing, which typically can take many months of time, needs to be performed. This generally delays the ‘release’ of the new business rules by several months. In many cases, such delays needed to incorporate the changes to business rules can adversely affect the commercial or operations units of an enterprise. Business Rules Engine (BRE) technology offers a solution to the above problem by facilitating (i) the externalization of business rules from the rest of the logic of IT systems and (ii) enabling the rules to be changed, tested and deployed without the IT system being re-compiled.

However, there still is a need for a method and system to provide for integrated and platform independent modeling of business rules.

### SUMMARY OF THE INVENTION

The above and other needs are addressed by the present invention which provides a method, system, and software with exemplary embodiments, including an ability to (i) create and maintain platform independent rules using business and application domain ontologies, (ii) explicitly and declaratively define the relationships between application components and rule categories, their structures and other meta-data and (iii) map business and application domain ontologies to platform specific application design elements.

Accordingly, in an exemplary aspects there is provided a method, system, and computer program product for integrated and platform independent modeling of business rules, including ***.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a conventional hard-coded business rules implementation methodology;

FIG. 2 illustrates a conventional platform specific business rules implementation methodology; and

FIGS. 3-8 are used to illustrate a method, system, and computer program product for integrated and platform independent modeling of business rules using business and application domain ontologies, according to exemplary embodiments of the present invention.

### DETAILED DESCRIPTION OF THE PREFERRED EMBODIMENTS

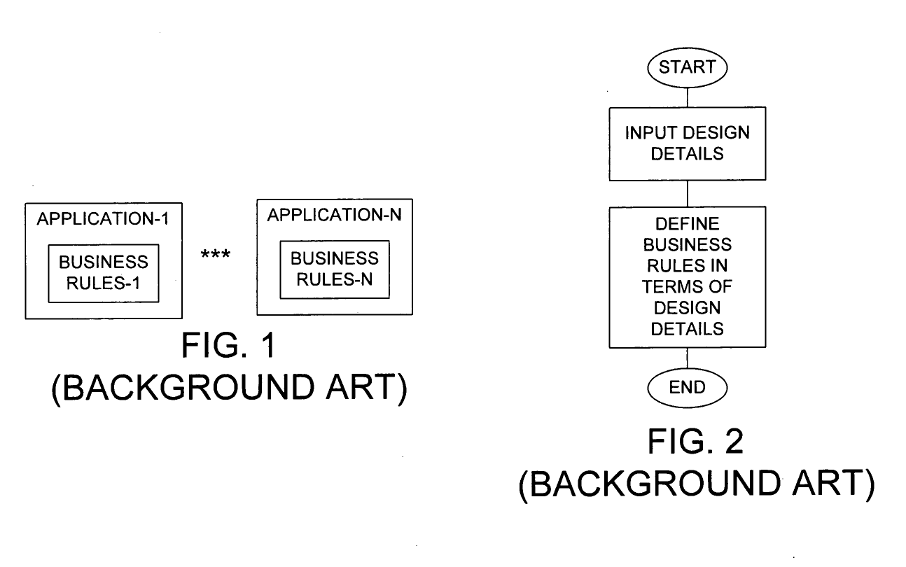

Referring now to the drawings, wherein like reference numerals designate identical or corresponding parts throughout the several views, and more particularly to FIGS. 1-8 thereof, which will be used to illustrate a method, system, and computer program product for integrated and platform independent modeling of business rules using business and application domain ontologies, according to exemplary embodiments of the present invention.

The present invention includes the recognition that current Business Rules Engine (BRE) technology provides (i) the ability to import application specific design files (e.g., ‘jar’ files, and the like) and define alternate names (e.g., business vocabulary based phrases) to the technology specific names of data elements and functions, (ii) the ability to create and maintain rule sets and rule flows, (iii) the ability to create and maintain rules using the alternate names of data elements and functions and insert rules into specific rule sets, (iv) the ability to create and maintain rule templates, which make it easier to create and maintain rules, (v) the ability to test and debug rule sets and rule flows, (vi) the ability to deploy rule sets and rule flows into a production environment, (vii) the ability to interpret rules within a rule set or rule flow at run-time against a given set of facts using exemplary techniques, such as the Rete algorithm, and the like.

The present invention further includes the recognition that many of the current business rules tools in the market have major drawbacks, including (i) the business rules being tightly linked to a particular technology platform rather than being platform independent, thereby making the re-use of business rules very difficult, (ii) the business vocabulary, which is used to express the business rules is defined in an informal way, thereby making it difficult to ensure the consistency of this vocabulary, and (iii) the relationships between the application components and the rules (e.g. what categories of rules are consumed by what application components) are hard-coded into the application code, thereby making them difficult to change.

The present invention further includes the recognition that some of the major drawbacks of the business rules technology and the supporting tools include technology specific design details (e.g., such as ‘jar’ files of J2EE environment based applications) being imported as a first step by the current tools and then the business domain vocabulary and business rules being defined in relation to the imported design, as shown in FIG. 2.

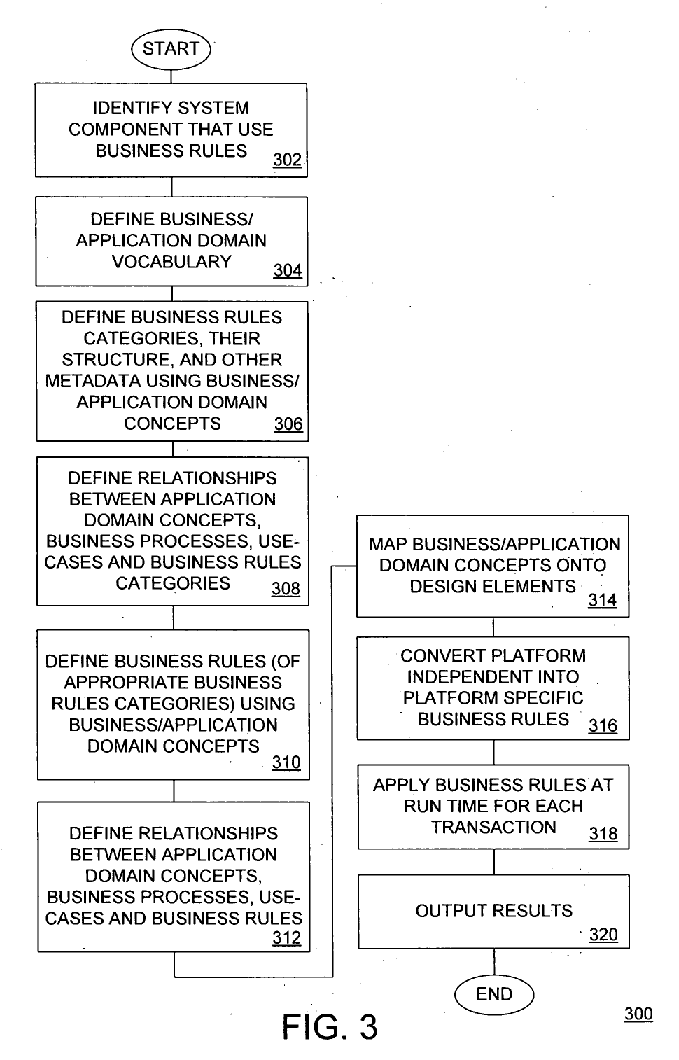

By contrast, as shown in FIG. 3, the exemplary embodiments identify system components that use business rules (step 302), define business/application domain vocabulary (step 304), define business rules categories, their structure, and other metadata using business/application domain concepts (step 306), define relationships between application domain concepts, business processes, use cases and business rules categories (step 308), define business rules (e.g., of appropriate business rules categories) using business/application domain concepts (step 310), define relationships between application domain concepts, business processes, use cases and business rules (step 312), map business/application domain concepts onto design elements (step 314), convert platform-independent into platform specific business rules (step 316), apply business rules at run-time for each transaction (step 318), and output the corresponding results (step 320), completing the exemplary process.

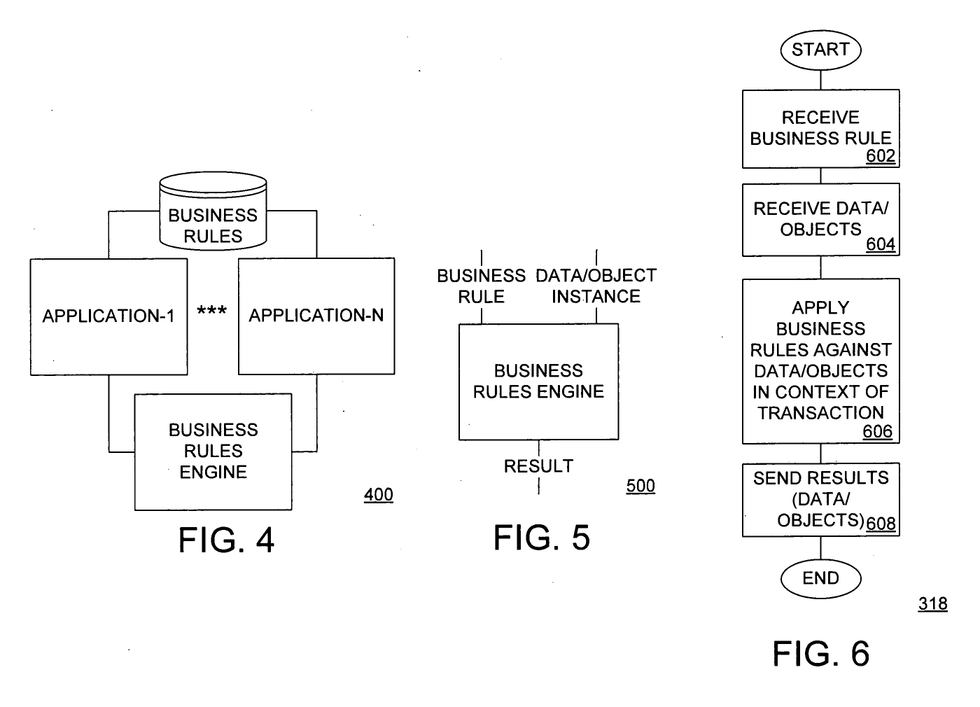

Advantageously, the exemplary embodiments facilitate the conversion of a same set of business rules into multiple technology independent platforms, as shown in FIG. 4. For example, in large enterprises, it is possible that business rules are common to different lines of businesses (LOBs) and the information technology (IT) systems for such different LOBs are implemented using different technology platforms. In addition, it is possible that the IT systems for a given LOB might be running on a technology platform ‘X’ (e.g., a legacy system) for some years and may later need to be ported onto a different technology platform ‘Y’ (e.g., a J2EE platform). In such scenarios, the exemplary embodiments, advantageously, facilitate the re-use of the business rules without having to re-define them all over again.

As further illustrated with reference to FIGS. 5-6, in step 318 of FIG. 3 the exemplary embodiments receive business rules (step 602) and data/object instances (step 604), and apply the business rules against the data/object instances passed on to it in the context of a transaction (step 606), and return the results obtained by executing the applicable rules (step 608).

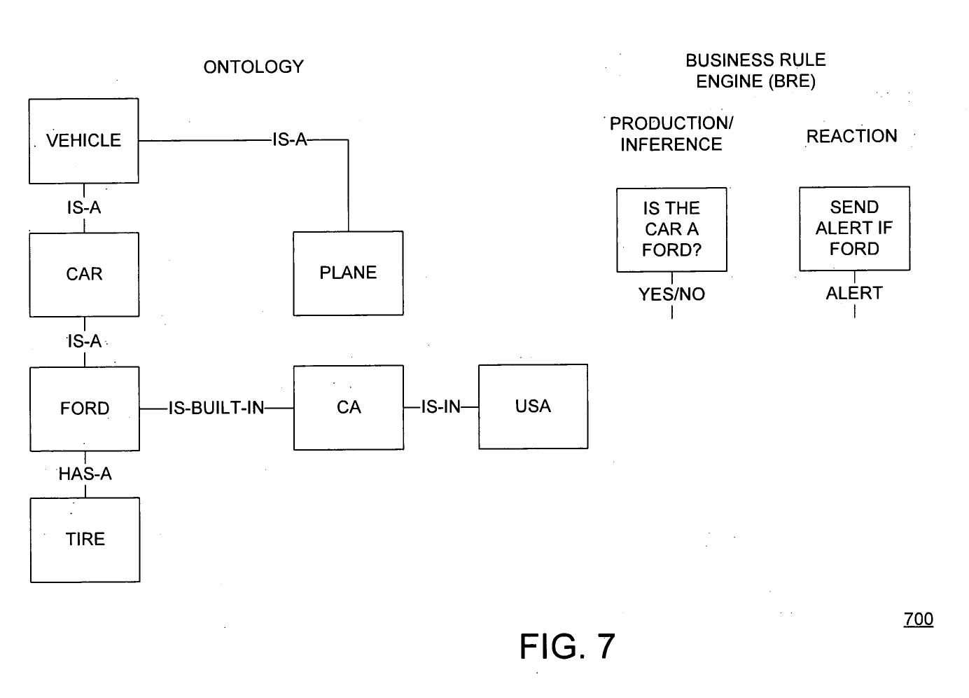

The present invention further includes the recognition that some of the major drawbacks of the business rules technology and the supporting tools include the business domain vocabulary being defined in an informal manner (e.g., as alternate names of data element and function names) by the current tools, and which can potentially lead to inconsistent definitions (e.g., unless one manually ensures the consistency). By contrast, the exemplary embodiments, advantageously, define the business domain vocabulary using a consistent formal model, such as ontology, and the like. FIG. 7 illustrates ontology and business rules engine concepts.

The present invention further includes the recognition that some of the major drawbacks of the business rules technology and the supporting tools include the relationships between, (a) the business domain ontology and the rules that are defined using these ontology, and (b) the application domain ontology (e.g., which includes (i) application domain concepts, their properties and inter-relationships, and (ii) business-processes/use-cases of the application domain) and the rules that are defined using and associated with the application domain concepts and that are consumed by the business processes/use-cases, not being explicitly defined and maintained by the current tools. This is a major handicap, as an IT architect employs such details to understand and design the interactions between the components of the various business applications (e.g., corresponding to the business-processes/use-cases) and the rules. These relationships can also help other stakeholders (e.g., such as business users, BRE implementation team, and the like) to understand better how the rules are used by the business applications.

The present invention further includes the recognition that some of the major drawbacks of the business rules technology and the supporting tools include categories, structure and other meta-data of rules employed by application components not being explicitly defined and maintained by the current tools. For example, a typical business rules implementation may involve a wide range of rule categories and their associated structures, wherein different business-processes/use-cases consume rules belonging to one or more of rule categories. Accordingly, if a business rules tool does not facilitate an explicit creation and maintenance of the above details, it would require the business rules implementation team to manually maintain and enforce the above structures and relationships. Such a manual dependency can potentially lead to human errors and reduced productivity during a business rules implementation.

The exemplary embodiments, advantageously, address the above and other short-comings of the current business rules technologies and the supporting tools. Accordingly, the exemplary embodiments (i) model rules using business and application domain ontologies, (ii) explicitly and declaratively define the relationships between application components and rule categories, their structures and other meta-data, and (iii) map business and application domain ontologies to platform specific application design elements. Advantageously, the exemplary BRE of the exemplary embodiments (i) enables the business rules implementation team and other stake-holders to query and know the relationships between application domain components and rules, such as the categories of rules consumed, the structure of such rules, and the like, (ii) eliminates the need to hard-code the names and categories of rule sets into an application component and thus make it easier to maintain such details, and (iii) enables the re-use of business rules across varying business rules implementations.

Accordingly, the exemplary embodiments, advantageously, offer a novel declarative and platform independent way to model business rules along with their relationships to application and business domain ontologies, which is significantly new advancement in the business rules technology space. Thus, the exemplary embodiments offer the following benefits, including:

(i) Flexibility: In the current business rules implementations, the set of rules that are consumed by a given application component are hard-coded in that component. This fact has a serious impact on the degree of flexibility. For example, if the set of rules consumed by an application component needs to be changed, it requires the code of that application component to be changed, tested and re-deployed. By contrast, the exemplary embodiments enable a given application component to query and find out the set of rules associated therewith through the explicitly maintained relationships. Advantageously, such a facility enhances flexibility by allowing an application component to dynamically invoke a new set of rules, without requiring any substantial code changes to that component.

(ii) Automated Enforcement: In the current business rules implementations, there is a need to ensure that the correct categories of rules are consumed by the various application components. Manual means to ensure this can lead to human errors and loss of productivity. By contrast, the exemplary embodiments automatically enforce such relationships, since such relationships are explicitly and declaratively defined, thereby enhancing the productivity of a business rules implementation.

(iii) Re-usability: In the current business rules implementations, the rules are tightly coupled to the underlying platform on which the IT systems (e.g., which consume the rules) have been implemented. The technology dependent design elements of the IT systems act as a starting point for defining the rules. For example, for a business rules implementation involving IT systems built using the J2EE platform, the ‘jar’ files (e.g., which include the object classes) act as the starting point for defining the business rules. This has an impact on the reusability of the business rules. For example, if the business rules need to be reused in the context of another BRE implementation, it becomes difficult to do so. By contrast, the exemplary embodiments support the creation and maintenance of rules, for example, using application domain and business domain ontologies, and the like. Such a platform independent approach to modeling business rules, advantageously, enables their re-use for business rules implementations on various different platforms.

(iv) Traceability: In the current business rules implementations, the relationships between the application components and the set of rules that they consume are embedded in the application code. In such a scenario, it is difficult for business users to find out the sets of rules that are consumed by different application components. In addition, when a set of business rules change, it is difficult for the business rules implementation team to find out the components of the application code that would get impacted. By contrast, the exemplary embodiments explicitly and declaratively define the relationships between the various application components and the sets of business rules that they consume, thereby automatically providing the required traceability for all suitable stake-holders.

Accordingly, the exemplary embodiments address the above and other major drawbacks of the current business rules technologies, and offer a paradigm shift in modeling the business rules and their relationships to application components.

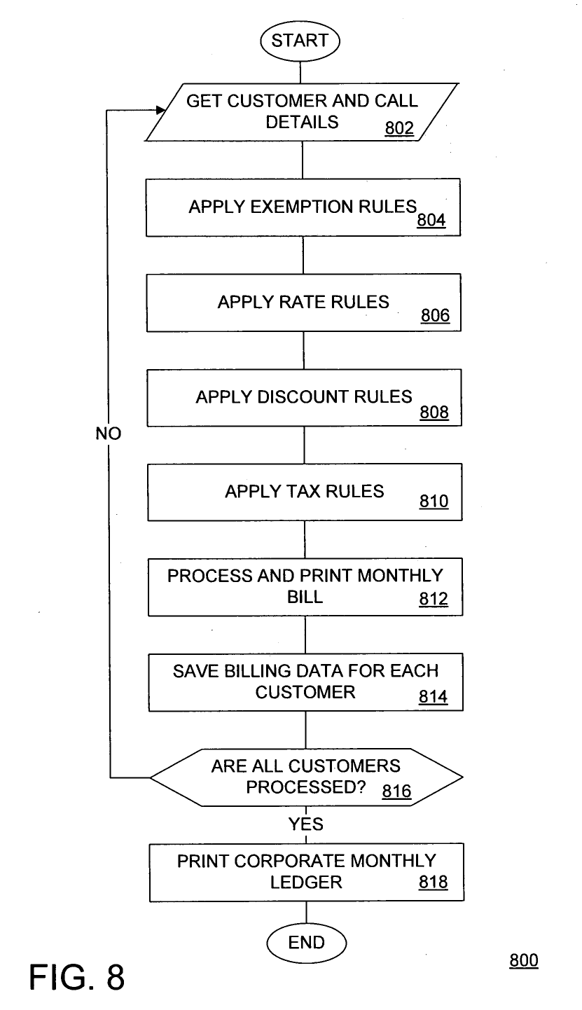

An exemplary use case will now be illustrated with reference to FIG. 8 and Tables 1-8, as follows. For example, a mobile service provider (Telecom Company, ABC Inc.) categorizes customers as ‘Gold’, ‘Silver’ and ‘Bronze’ subscribers. Depending on the customer category, the free outgoing calls, free Short Message Service (SMS) messages, the discounts and rates, and the like, are planned, as shown in the Tables 1-2 below:

TABLE 1
Gold, Silver and Bronze Plans Details

| | Incoming call | Outgoing call | |
|---|---|---|---|
| | charges (USD per | charges (USD per | SMS charges |
| Customer class | Min) | Min) | (USD per Min) |
| Gold | 0.1 | 0.2 | 0.1 |
| Silver | 0.15 | 0.25 | 0.1 |
| Bronze | 0.2 | 0.3 | 0.1 |

TABLE 2
Gold, Silver and Bronze Plans Details

| | | Minimum | | |
|---|---|---|---|---|
| Customer | Free | Monthly | | |
| class | outgoing | Charges | SMS Charges | Discount |
| Gold | 30 min | 1000 | free during the | 3% if monthly |
| | | | weekends | bill exceeds |
| | | | | 2000 else NIL |
| Silver | 20 min | 750 | Free only on | 2% if monthly |
| | | | Sundays | bill exceeds |
| | | | | 2000 else NIL |
| Bronze | 10 min | 500 | No offer | 1% if monthly |
| | | | | bill exceeds |
| | | | | 2000 else NIL |

FIG. 8 and Tables 1-8 illustrate the exemplary processes performed for the Billing Application Details of Telecom Company, ABC Inc. In FIG. 8, using Tables 3-8, customer and call details are obtained (step 802), exemption rules are applied (step 804), rates rules are applied (step 806), discount rules are applied (step 808), tax rules are applied (step 810), the monthly bill is processed and printed (step 812), billing data for each customer is saved (step 814), all customers are processed (step 816, and steps 802-814 are repeated, as needed), the Corporate Monthly Ledger is printed (step 818), completing the exemplary process.

TABLE 3
Business Domain Vocabulary/Ontology

| Concept | Attributes | Type |
|---|---|---|
| Call | Calling Party Number | Integer (With min |
| | | and max digits) |
| | Called Party Number | Integer (With min |
| | | and max digits) |
| | Duration | Time |
| SMS | SMS Time | Time |
| Customer | Unique Identification | Number |
| | First Name | String |
| | Last Name | String |
| | Address | String |
| | Category | Allowed Values |
| | | (say “Gold”, |
| | | “Silver”, “Bronze”) |
| | Call Usage Exemption | Concept |
| Call Usage | Outgoing Calls | Time |
| Exemption | SMS | Time |

TABLE 4a
Application Domain Vocabulary/Ontology - Concepts

| Concept | Attributes | Type |
|---|---|---|
| Bill | Fixed Charges | Concept |
| | Variable Charges | Concept |
| Fixed Charges | Bill Plan Charges | Amount |
| | Calling Line Identification | Amount |
| | Charges | |
| Variable Charges | SMS Charges | Amount |
| | Local Call Charges | Amount |
| | National Call Charges | Amount |
| | International Call Charges | Amount |

TABLE 4B
Application Domain Vocabulary/Ontology - Business
Processes/Use-Cases

| Business Processes/ | | |
|---|---|---|
| Use-Cases | Attributes | Type |
| Capture Call Details | Get Call Data Records for a | Method |
| | given Customer's Unique | |
| | Identification | |
| Compute Bill | Calculate Fixed Charges | Method |
| | Calculate Variable Charges | Method |
| Print Bill | Generate Monthly Bill for a | Method |
| | given Customer's Unique | |
| | Identification | |

TABLE 5
Relationship between Application Domain Concepts and
Rule Categories

| Application Domain | |
|---|---|
| Concept | Associated Rule Categories |
| Fixed Charges | Fixed Charges Calculation Rules |
| Variable Charges | Call Usage Exemption Rules |
| | Call Usage Rate Rules |
| | Call Usage Discount Rules |

TABLE 6
Relationship between Business Processes/Use Cases and
Rule Categories

| Business Process/ | |
|---|---|
| Use-Case | Associated Rule Categories |
| Calculate Fixed Charges | Fixed Charges Calculation Rules |
| Calculate Variable charges | Call Usage Exemption Rules |
| | Call Usage Rate Rules |
| | Call Usage Discount Rules |

TABLE 7
Structure and Metadata of Rule Categories

| | | | Meta data | |
|---|---|---|---|---|
| | | | | Applicability |
| Rule Category | Rule Structure | | Author | Period |
| Fixed Charges | Condition Part: | | John Abraham | Jan-01-2007 |
| Calculation Rules | (Customer.Category IS | GOLD | | To |
| | | Silver | | Dec-31-2007 |
| | | Bronze) | | |
| | Action Part: | | | |
| | (Bill.Fixed Charges Bill Plan Charges IS | | | |
| | - ---- ---- ---- ---- dollars) | | | |
| Call Usage | Condition Part: | | Jill Gerhart | Jan-01-2007 |
| Exemption Rules | (Customer.Category IS | GOLD | | To |
| | | Silver | | Dec-31-2007 |
| | | Bronze) | | |

Action part:
(Customer.Call Usage Exemption.Outgoing
Calls IS - - -- ---- ---- ---- minutes)
AND
(Customer.Call Usage Exemption.SMS IS
- ---- ---- ---- - minutes

TABLE 8
Rules Contained in Rule Categories

| Rule | |
|---|---|
| Categories | Associated Rules |
| Fixed Charges | R1: Monthly bill ceilings - customer category ‘Gold’ |
| Calculation | If (Customer. Category IS ‘Gold’) |
| Rules | Then |
| | (Set Bill.Fixed Charges.Bill Plan Charges to USD 1000) |
| | R2: Monthly bill ceilings - customer category ‘Silver’ |
| | If(Customer. Category IS ‘Silver’) |
| | Then |
| | (Set Bill.Fixed Charges.Bill Plan Charges to USD 750) |
| Call Usage | R1: Category ‘Gold’ customer exemptions |
| Exemption | If(Customer.Category IS ‘Gold’) |
| Rules | Then |
| | (Set Customer.Call Usage Exemption.Outgoing |
| | Calls to 30 minutes) |
| | AND |
| | (Set Customer.Call Usage Exemption.SMS to weekend) |
| | R2: Category ‘Silver’ customer exemptions |
| | If(Customer.Category IS ‘Silver’) |
| | Then |
| | (Set Customer.Call Usage Exemption.Outgoing |
| | Calls to 20 minutes) |
| | AND |
| | (Set Customer.Call Usage Exemption.SMS to Sunday) |

The exemplary embodiments thus include the following exemplary features, for example, including:

(a) The ability to create and maintain (e.g., add, delete and update, save, load, and the like) platform independent business domain ontologies that facilitate the definition of business domain concepts, their properties and inter-relationships; and (b) The ability to create and maintain (e.g., add, delete and update, save, load, and the like) platform independent application domain ontologies that facilitate the definition of (i) application domain concepts, their properties and inter-relationships and (ii) business-processes/use-cases of the application domain (Tables 3 and 4).

(c) The ability to create and maintain (e.g., add, delete and update, save, load, and the like) platform independent business rule categories and their associated structures (e.g., composition of/restrictions on conditions and actions of rules) and other meta-data using business domain and application domain concepts and their properties (Table 7).

(d) The ability to create and maintain (e.g., add, delete and update, save, load, and the like) the associations between application domain concepts, their properties, and the business rule categories (Table 5).

(e) The ability to create and maintain (e.g., add, delete and update, save, load, and the like) the associations between the business-processes/use-cases and the business rule categories (Table 6).

(f) The ability to create and maintain (e.g., add, delete and update, save, load, and the like) platform independent business rules of the appropriate business rule categories using business domain and application domain concepts and their properties (e.g., as determined by the structure of the business rule categories, Table 8).

(g) The ability to create and maintain (e.g., add, delete and update, save, load, and the like) the associations between application domain concepts, their properties and the business rules.

(h) The ability to create and maintain (e.g., add, delete and update, save, load, and the like) the consumption relationships between the business-processes/use-cases and the business rules.

(i) The ability to map the business domain and application domain ontologies to platform specific elements (e.g., such as OO classes).

(j) The ability to convert platform independent business rules into platform specific business rules using the mappings created in step (i) above.

The above-described devices and subsystems of the exemplary embodiments of FIGS. 3-8 can include, for example, any suitable servers, workstations, PCs, laptop computers, PDAs, Internet appliances, handheld devices, cellular telephones, wireless devices, other devices, and the like, capable of performing the processes of the exemplary embodiments of FIGS. 3-8. The devices and subsystems of the exemplary embodiments of FIGS. 3-8 can communicate with each other using any suitable protocol and can be implemented using one or more programmed computer systems or devices.

One or more interface mechanisms can be used with the exemplary embodiments of FIGS. 3-8, including, for example, Internet access, telecommunications in any suitable form (e.g., voice, modem, and the like), wireless communications media, and the like. For example, the employed communications networks can include one or more wireless communications networks, cellular communications networks, 3 G communications networks, Public Switched Telephone Network (PSTNs), Packet Data Networks (PDNs), the Internet, intranets, a combination thereof, and the like.

It is to be understood that the devices and subsystems of the exemplary embodiments of FIGS. 3-8 are for exemplary purposes, as many variations of the specific hardware and/or software used to implement the exemplary embodiments are possible, as will be appreciated by those skilled in the relevant art(s). For example, the functionality of one or more of the devices and subsystems of the exemplary embodiments of FIGS. 3-8 can be implemented via one or more programmed computer systems or devices.

To implement such variations as well as other variations, a single computer system can be programmed to perform the special purpose functions of one or more of the devices and subsystems of the exemplary embodiments of FIGS. 3-8. On the other hand, two or more programmed computer systems or devices can be substituted for any one of the devices and subsystems of the exemplary embodiments of FIGS. 3-8. Accordingly, principles and advantages of distributed processing, such as redundancy, replication, and the like, also can be implemented, as desired, to increase the robustness and performance the devices and subsystems of the exemplary embodiments of FIGS. 3-8.

The devices and subsystems of the exemplary embodiments of FIGS. 3-8 can store information relating to various processes described herein. This information can be stored in one or more memories, such as a hard disk, optical disk, magneto-optical disk, RAM, and the like, of the devices and subsystems of the exemplary embodiments of FIGS. 3-8. One or more databases of the devices and subsystems of the exemplary embodiments of FIGS. 3-8 can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments of FIGS. 3-8 can include appropriate data structures for storing data collected and/or generated by the processes of the devices and subsystems of the exemplary embodiments of FIGS. 3-8 in one or more databases thereof.

All or a portion of the devices and subsystems of the exemplary embodiments of FIGS. 3-8 can be conveniently implemented using one or more general purpose computer systems, microprocessors, digital signal processors, micro-controllers, and the like, programmed according to the teachings of the exemplary embodiments of the present invention, as will be appreciated by those skilled in the computer and software arts. Appropriate software can be readily prepared by programmers of ordinary skill based on the teachings of the exemplary embodiments, as will be appreciated by those skilled in the software art. In addition, the devices and subsystems of the exemplary embodiments of FIGS. 3-8 can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present invention can include software for controlling the devices and subsystems of the exemplary embodiments of FIGS. 3-8, for driving the devices and subsystems of the exemplary embodiments of FIGS. 3-8, for enabling the devices and subsystems of the exemplary embodiments of FIGS. 3-8 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the exemplary embodiments of FIGS. 3-8. Computer code devices of the exemplary embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present invention can be distributed for better performance, reliability, cost, and the like.

As stated above, the devices and subsystems of the exemplary embodiments of FIGS. 3-8 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of exemplary embodiments and implementations, the present invention is not so limited, but rather covers various modifications and equivalent arrangements, which fall within the purview of the appended claims.

What we claim is:

1. A method for integrated and platform independent modeling of business rules, the method comprising:
identifying a component of a system that applies a segment of a business rule;
externalizing the segment of the business rule from business procedural logic of the component; and
applying the externalized segment of the business rule at run time,
whereby components of the system use the externalized segment of the business rule in a platform independent manner.

2. The method of claim 1, wherein the system includes an information technology (IT) system.

3. The method of claim 1, wherein the externalizing step includes externalizing the segment of the business rule from business procedural logic of the component into a business rules repository.

4. The method of claim 1, further comprising:
invoking a business rules engine for each transaction of the system;
receiving by the business rules engine a business rule and a data or object instance;
applying by the business rules engine the business rule against the data or object instance in the context of the transaction; and
returning by the business rules engine a result obtained by executing the business rule.

5. The method of claim 1, further comprising creating and maintaining platform independent business rule categories and associated structures and other meta-data using business domain and application domain concepts and properties thereof.

6. The method of claim 5, wherein the rule categories and associated structures include composition of conditions and actions of business rules, and restrictions on conditions and actions of business rules.

7. The method of claim 5, further comprising creating and maintaining the associations between the application domain concepts and the properties thereof, and the business rule categories.

8. The method of claim 5, further comprising creating and maintaining associations between business-processes or use-cases and the business rule categories.

9. The method of claim 5, further comprising creating and maintaining platform independent business rules of the business rule categories using business domain and application domain concepts and properties thereof.

10. The method of claim 9, further comprising determining the business domain and application domain concepts and properties thereof based on a structure of the business rule categories.

11. The method of claim 6, further comprising creating and maintaining the associations between the application domain concepts and properties thereof, and the business rules.

12. The method of claim 8, further comprising creating and maintaining consumption relationships between the business-processes or use-cases and the business rules.

13. The method of claim 5, wherein the creating and maintaining step includes add, delete, update, save, and load functions.

14. A system for integrated and platform independent modeling of business rules, the system comprising:
means for identifying a component of a system that applies a segment of a business rule;
means for externalizing, the segment of the business rule from business procedural logic of the component; and
means for applying the externalized segment of the business rule at run time,
whereby components of the system use the externalized segment of the business rule in a platform independent manner.

15. The system of claim 14, wherein the system includes an information technology (IT) system.

16. The system of claim 14, wherein the externalizing means includes means for externalizing the segment of the business rule from business procedural logic of the component into a business rules repository.

17. The system of claim 14, further comprising:
a business rules engine invoked for each transaction of the system,
wherein the business rules engine in configured to receive a business rule and a data or object instance,
the business rules engine is configured to apply the business rule against the data or object instance in the context of the transaction, and
the business rules engine is configured to return a result obtained by executing the business rule.

18. The system of claim 14, further comprising means for creating and maintaining platform independent business rule categories and associated structures and other meta-data using business domain and application domain concepts and properties thereof.

19. The system of claim 18, wherein the rule categories and associated structures include composition of conditions and actions of business rules, and restrictions on conditions and actions of business rules.

20. The system of claim 18, further comprising means for creating and maintaining the associations between the application domain concepts and the properties thereof, and the business rule categories.

21. The system of claim 18, further comprising means for creating and maintaining associations between business-processes or use-cases and the business rule categories.

22. The system of claim 18, further comprising means for creating and maintaining platform independent business rules of the business rule categories using business domain and application domain concepts and properties thereof.

23. The system of claim 22, further comprising determining the business domain and application domain concepts and properties thereof based on a structure of the business rule categories.

24. The system of claim 19, further comprising means for creating and maintaining the associations between the application domain concepts and properties thereof, and the business rules.

25. The system of claim 21, further comprising creating and maintaining consumption relationships between the business-processes or use-cases and the business rules.

26. The system of claim 18, wherein the creating and maintaining means includes means for providing add, delete, update, save, and load functions.

27. A computer storage device tangibly embodying a plurality of instructions on a computer readable medium for integrated and platform independent modeling of business rules, comprising the steps of:
identifying a component of a system that applies a segment of a business rule;
externalizing the segment of the business rule from business procedural logic of the component; and
applying the externalized segment of the business rule at run time,
whereby components of the system use the externalized segment of the business rule in a platform independent manner.

28. The computer storage device of claim 27, wherein the system includes an information technology (IT) system.

29. The computer storage device of claim 27, wherein the externalizing step includes externalizing the segment of the business rule from business procedural logic of the component into a business rules repository.

30. The computer storage device of claim 27, further comprising:
invoking a business rules engine for each transaction of the system;
receiving by the business rules engine a business rule and a data or object instance;
applying by the business rules engine the business rule against the data or object instance in the context of the transaction; and
returning by the business rules engine a result obtained by executing the business rule.

31. The computer storage device of claim 27, further comprising creating and maintaining platform independent business rule categories and associated structures and other meta-data using business domain and application domain concepts and properties thereof.

32. The computer storage device of claim 31, wherein the rule categories and associated structures include composition of conditions and actions of business rules, and restrictions on conditions and actions of business rules.

33. The computer storage device of claim 31, further comprising creating and maintaining the associations between the application domain concepts and the properties thereof, and the business rule categories.

34. The computer storage device of claim 31, further comprising creating and maintaining associations between business-processes or use-cases and the business rule categories.

35. The computer storage device of claim 31, further comprising creating and maintaining platform independent business rules of the business rule categories using business domain and application domain concepts and properties thereof.

36. The computer storage device of claim 35, further comprising determining the business domain and application domain concepts and properties thereof based on a structure of the business rule categories.

37. The computer storage device of claim 32, further comprising creating and maintaining the associations between the application domain concepts and properties thereof, and the business rules.

38. The computer storage device of claim 34, further comprising creating and maintaining consumption relationships between the business-processes or use-cases and the business rules.

39. The computer storage device of claims 31, wherein the creating and maintaining step includes add, delete, update, save, and load functions.
